(19) United States
(12) Patent Application Publication
(10) Pub. No.: US 2023/0271103 A1
(43) Pub. Date: Aug. 31, 2023

(54) PROCESS CONTROL SYSTEMS WITH SIMULATOR FOR USE WITH A MASS TRANSFER COLUMN

(71) Applicant: Koch-Glitsch, LP, Wichita, KS (US)

(72) Inventors: Izak NIEUWOUDT, Wichita, KS (US); Anand VENNAVELLI, Wichita, KS (US)

(21) Appl. No.: 18/016,484

(22) PCT Filed: Jun. 25, 2021
(86) PCT No.: PCT/IB2021/055706

§ 371 Date: Jan. 17, 2023

Related U.S. Application Data
(60) Provisional application No. 63/053,132, filed on Jul. 17, 2020.

(51) Int. Cl. B01D 3/42; B01D 53/14

(52) U.S. Cl. CPC B01D 3/4211; B01D 53/1412

(57) ABSTRACT

An automatic control system is provided for controlling the operation of a mass transfer system that includes a mass transfer column. The automatic control system includes a field data collection device that collects process data from the mass transfer system, a data collection module for receiving and storing process data received from the field data collection device, and an online simulator that includes a column simulation module for calculating a column performance parameter from the process data.

### RELATED APPLICATIONS

This application claims priority U.S. Provisional Patent Application No. 63/053,132, filed Jul. 17, 2020, which is incorporated herein by reference in its entirety.

### BACKGROUND

The present application generally relates to mass transfer columns and, more particularly, to methods and systems for controlling the operation and performance of the mass transfer column.

Mass transfer columns are used for separating fluids into two or more product streams of specific composition and/or temperature using a mass transfer column and its associated internals and equipment such as heat exchangers, piping, and valves. The term “mass transfer column” as used herein is intended to encompass separators, distillation columns, divided wall columns, liquid-liquid extractors, scrubbers, absorbers, and evaporators, which facilitate heat and/or mass transfer between two or more fluid phases. Some mass transfer columns, such as those used in multicomponent distillation and absorption, are configured to contact gas and liquid phases, while other mass transfer columns, like extractors, are configured to contact two liquid phases of differing density. Often, mass transfer columns include mass transfer structures, such as single- or multi-pass cross-flow trays, structured or random packing, or other components, which are disposed within the mass transfer column to provide surfaces on which the fluid phases can be contacted.

The rate and/or extent of contact between the two or more fluid phases within the mass transfer column determines the extent and efficiency of the separation. The more intimately and completely the phases are contacted with one another, the better the separation. Achieving higher separation efficiency permits increased throughput into the mass transfer column and/or higher purity products produced therein.

FIG. 4 depicts a prior art system for control of a mass transfer column 402. A process control system 404 is used to monitor and regulate the operation of the mass transfer column 402. A process operator 406 interfaces with the process control system 404 to implement controls that either automatically control the mass transfer column 402 or are implemented via process engineers 408. The process control system 404 receives data from sensors associated with the mass transfer column 402. The process control system 404 records (in data historian 410) values for various process parameters, such as temperature, pressure, and flow rate, at certain locations within the mass transfer column 402. Then, by comparing a measured value of a parameter with a set point or target value for that parameter, the process control system 404 can be used to make adjustments to valves, pumps or other control devices within the system so that the measured value more closely matches the set point.

At times, process control systems may be programmed to perform relatively simple calculations as indicated by analytics 412. More complex calculations, such as those required to determine performance parameters of the mass transfer column 402, are typically done offline 414 since conventional process control systems normally do not have the functionality to provide those parameter values. These offline calculations 414 use data from the data historian 410 and appropriate operating parameters are transmitted back to the data historian 410 and the process control system 404. However, because these calculations are done offline, there is a significant delay between the time the data is pulled from the data historian 410 to the time the operating parameters are returned (sometimes as many as one to multiple weeks of delay). During this delay, however, the mass transfer column 402 is either shut down (if there is a safety or environmental risk) or continues operating with uncertain performance parameters. Shutting down the mass transfer column 402 is clearly not ideal because any operating profits are not realized. If the mass transfer column 402 continues operation, the returned operating parameters are already less-than-ideal because the state of the mass transfer column 402 may have changed during the delay time. Thus, even if offline and more complex analysis is performed, the results lag the current operating state of the mass transfer column 402.

Thus, a need exists for a process control system that is capable of providing column performance parameters online and in close to real-time. In so doing, the values of the parameters could be used by operations personnel to operate, troubleshoot, and optimize the mass transfer system, thereby resulting in enhanced performance and production. Further, such parameters could be used to extend the run time and/or increase the operational efficiency of the mass transfer column, resulting in higher product volume and/or quality and/or reduced expenses.

### SUMMARY

The performance of the mass transfer column is monitored using various column performance parameters such as tray entrainment, froth height, and liquid hold up on packing that quantify the interaction between the fluid phases within the column. These parameters are not measured directly but, instead, are calculated from process data, such as temperature, pressure, flow rates, and compositions, obtained at various locations within the mass transfer column and are based, at least in part, on the type, location, and dimensions of the mass transfer column internals. Such calculations are complex and often require input from external parties, such as the column designer or vendors of the internal components. As a result, values for these column performance parameters may not be available online or in real-time, so the use of these variables in optimizing and troubleshooting the operation of a mass transfer column may be severely limited.

However, these parameters could provide valuable information about the operation of the mass transfer column. For example, by comparing values for these parameters with their design values or calculated target values, operations personnel would be in a better position to identify problems, such as flooding or entrainment, within the mass transfer column and make the adjustments necessary to improve operational performance. At present, the amount of time required to obtain values for these parameters offline is often substantial, making it difficult to use these parameters as accurate reflections of the mass transfer column's current performance. Thus, these parameters are not regularly used to adjust column operation. Further, by evaluating trends of these parameters, operations personnel could also more rapidly identify problems, such as plugging, fouling or tray damage, within the mass transfer column, thereby maximizing performance of the mass transfer column.

In one aspect, the present disclosure is directed to an automatic control system for controlling the operation of a mass transfer system. The system comprises at least one field data collection device for collecting process data from the mass transfer system; at least one data collection module for receiving and storing process data received from the field data collection device; and an online simulator comprising a column simulation module for calculating a column performance parameter from the process data.

In another aspect, the present disclosure is directed to a mass transfer system comprising: a mass transfer column comprising a column shell; and a plurality of mass transfer elements disposed within the column shell for facilitating contact between two fluid phases within the column shell. The mass transfer system also comprises an automatic control system for calculating at least one column performance parameter related to the mass transfer column in real-time, wherein the column performance parameter is selected from the group consisting of tray entrainment, tray froth height, tray jet flood, tray weeping, tray downcomer backup, tray downcomer choke flooding, tray maldistribution, packing percentage of flood, packing liquid hold-up, and packing maldistribution.

In a further aspect, the present disclosure is directed to a method for controlling a mass transfer system, the method comprising: (a) measuring at least one process parameter value of the mass transfer system with at least one field data collection device; (b) simulating the operation of the mass transfer system with the measured process parameter value to provide a process profile, wherein the simulating is carried out with a process simulator module of an automatic control system; (c) simulating the performance of a mass transfer column of the mass transfer system with the simulated process data to provide a column performance parameter value, wherein the simulating is carried out with a column simulator module of the automatic control system; and (d) displaying the column performance parameter value to at least one user via a display module.

In a still further aspect, the present disclosure is directed to a method for controlling a mass transfer system, the method comprising: (a) introducing a feed stream into a mass transfer column of the mass transfer system; (b) contacting at least a portion of the feed stream with at least one mass transfer element in the column to facilitate interaction between two or more fluid phases therein; and (c) during at least a portion of the contacting, calculating and displaying a real-time value for at least one column performance parameter with an automatic control system, wherein the column performance parameter is selected from the group consisting of tray entrainment, tray froth height, tray jet flood, tray weeping, tray downcomer backup, tray downcomer choke flooding, tray maldistribution, packing percentage of flood, packing liquid hold-up, packing maldistribution, and combinations thereof.

### BRIEF DESCRIPTION OF THE FIGURES

In the accompanying drawings that form part of the specification and in which like reference numerals are used to indicated like components in the various views:

FIG. 1 is a schematic depiction of a mass transfer system according to one embodiment, generally illustrating the location of various system components and elements of the automatic control system;

FIG. 2 is a schematic block diagram of an embodiment of the automatic control system suitable for use in controlling the operation of the mass transfer system;

FIG. 3 depicts an example screen for displaying on the display including the data from the column simulation module, in an embodiment; and

FIG. 4 depicts a prior art system for control of a process system.

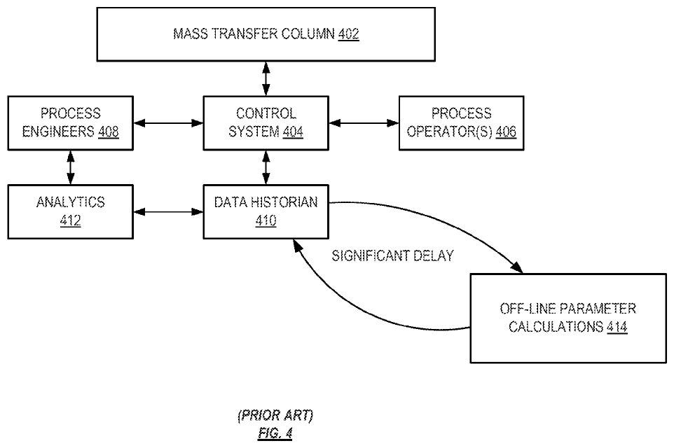

### DETAILED DESCRIPTION OF THE PREFERRED EMBODIMENTS

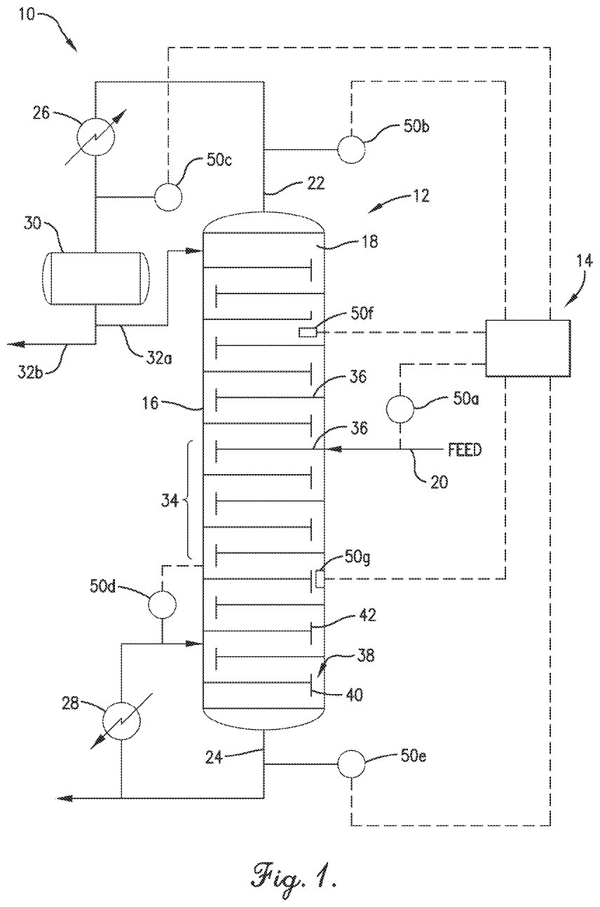

Turning now to the drawings in greater detail and initially to FIG. 1, a mass transfer system suitable for use in a variety of mass transfer, heat exchange, and/or reaction processes is represented generally by the numeral 10. The mass transfer system 10 includes at least one mass transfer column 12 and an automatic control system 14. Although shown in FIG. 1 as including a single mass transfer column 12, the mass transfer system 10 may include multiple ones ofthe mass transfer column 12 arranged in series or in parallel, each mass transfer system 10 having its own automatic control system 14 or sharing one or more automatic control system(s). The mass transfer system 10 may be located in any suitable type of processing facility including, but not limited to, a chemical processing plant, a petroleum refinery, a chemical production facility, a light hydrocarbon separation facility, and the like.

The mass transfer column 12 may be any type of column for processing fluid streams, usually liquid and vapor streams or two or more liquid streams having different densities, to obtain fractionation products, or to otherwise cause mass transfer and/or heat exchange between the fluid phases. Examples of suitable types of mass transfer columns 12 include, but are not limited to, separators, distillation columns, liquid-liquid extraction columns, scrubber columns, absorber columns, and evaporator columns. The mass transfer column 12 may be one in which crude atmospheric fractionating, lube or crude vacuum oil fractionation, catalytic or thermal cracking fractionating, coker or visbreaker fractionating, coker or cracking scrubbing, reactor off-gas scrubbing, gas quenching, edible oil deodorization, pollution control scrubbing, reactive distillation, or other types of processes occur.

As shown in FIG. 1, the mass transfer column 12 includes an external shell 16 that may have a cylindrical cross-sectional shape. The shell 16 may be either vertically oriented as shown in FIG. 1 or it may be horizontally oriented (or elongated). Other cross-sectional shapes, such as polygonal, are possible and may be used in mass transfer systems described herein. The shell 16 may be of any suitable diameter, thickness, and height or length, and constructed of rigid materials that are inert to, or compatible with, the fluids and conditions that are present during the operation of the mass transfer column 12.

The shell 16 of the mass transfer column 12 defines an open internal region 18 in which the desired mass transfer, heat exchange, and/or reaction between the fluid phases takes place. In one embodiment, the fluid phases within the mass transfer column 12 may include ascending vapor and descending liquid. In other embodiments, the fluid phases within the mass transfer column 12 may comprise substantially any combination of ascending or descending liquid and ascending or descending vapor. In some embodiments, the fluid phases within the mass transfer column 12 may include ascending or descending liquids having different densities. The fluid phases within the mass transfer column 12 may move in a co-current manner, such that the vapor and liquid phases, or both liquid phases, move in the same direction along a longitudinal axis of the mass transfer column 12, or the fluid streams within the mass transfer column 12 may move in a counter-current manner, such that the vapor or liquid phase moves in the opposite direction as the other phase within the mass transfer column 12.

One or more fluid streams may be introduced into the mass transfer column 12 via one or more feed lines, such as a feed line 20 shown in FIG. 1. In some embodiments (not shown in FIG. 1), the mass transfer system 10 may include additional feed lines for introducing other fluid streams at one or more other locations above and/or below the inlet of feed line 20 shown in FIG. 1. When the fluid streams contacted in the mass transfer column 12 include a vapor stream or phase, the vapor may be introduced into the mass transfer column 12 in the feed line 20 (or another separate feed line) and/or all or a portion of the vapor phase may be generated within the mass transfer column 12 during operation.

As also shown in FIG. 1, one or more fluid streams may be withdrawn from the mass transfer column 12 via one or more takeoff lines, shown as an upper (or overhead) takeoff line 22 and a lower (or bottom) takeoff line 24. In some embodiments, a vapor stream may be removed from the mass transfer column 12 via the upper takeoff line 22, while a liquid stream may be removed from the mass transfer column 12 via the lower takeoff line 24.

The mass transfer system 10 may also comprise one or more heat exchangers for heating and/or cooling the fluid streams introduced into and/or withdrawn from the mass transfer column 12. Heat exchangers help create and maintain a temperature profile along the height of the mass transfer column 12. The mass transfer system 10 shown in FIG. 1 includes a condenser 26 for cooling the overhead vapor stream withdrawn from the mass transfer column 12 via the takeoff line 22 and a reboiler 28 for heating the bottom liquid stream withdrawn from the mass transfer column 12 via the takeoff line 24. Additionally (although not shown in FIG. 1), the mass transfer system 10 may include one or more heat exchangers for heating or cooling the feed stream in the feed line 20 prior to its introduction into the mass transfer column 12.

The condenser 26 of the mass transfer system 10 is configured to cool and at least partially condense at least a portion of the overhead vapor stream in the upper takeoff line 22. The condenser 26 may be an indirect heat exchanger configured to transfer heat between the overhead vapor stream in the upper takeoff line 22 and at least one stream of heat transfer medium, such as air, cooling water, or another cooler process stream. Specific examples of heat exchangers suitable for use as the condenser 26 include, but are not limited to, shell-and-tube condensers, a plate-and-fin condenser, or air-cooled (forced draft or fin-fan) condensers.

As shown in FIG. 1, the cooled and at least partially condensed stream from the condenser 26 enters an overhead accumulator 30, wherein the vapor and liquid phases are separated. The predominantly liquid stream withdrawn from the accumulator 30 may be further split into a reflux portion 32a and an overhead product portion 32b. The reflux portion 32a is introduced back into an upper section of the mass transfer column 12, while the product portion 32b may be routed to further downstream processing, transportation, and/or storage (not shown).

The reboiler 28 of the mass transfer system 10 is configured to heat and at least partially vaporize at least a portion of the bottom liquid stream in the lower takeoff line 24. The reboiler 28 can be an indirect heat exchanger configured to transfer heat between a stream of heat transfer medium and the bottom liquid stream in line 24. Examples of heat transfer media include steam, a warmer process stream, and heated air (as in a furnace). Specific examples of heat exchangers suitable for use as the reboiler 28 include, but are not limited to, a kettle reboiler, a thermosyphon reboiler, a fired reboiler, and a forced circulation reboiler.

The mass transfer system 10 may include one or more side draw heat exchangers (not shown in FIG. 1) for heating or cooling a fluid stream withdrawn from and then returned to the mass transfer column 12. Such side draw heat exchangers may be positioned at one or more locations along the height of the mass transfer column 12 and may be of any of the types discussed herein. Side draw heat exchangers are used to maintain a desired temperature profile along the mass transfer column 12 and/or to optionally provide one or more side draw product steams of a specific composition. In some embodiments, a side draw heat exchanger receives a stream of vapor from the mass transfer column 12, cools and at least partially condenses it, and returns it to a different location (higher or lower) than the withdrawal location. In other embodiments, a side draw heat exchanger receives a stream of liquid from the mass transfer column 12, heats and at least partially vaporizes it, and returns it to a different location (lower or higher) on the column than the withdrawal location. The mass transfer column 12 can include one or more, or no, side draw heat exchangers.

The mass transfer column 12 further comprises one or more mass transfer structures disposed in the internal region 18 of the mass transfer column 12 for facilitating contact between different fluid phases. The mass transfer column 12 may include various piping, liquid distributors, liquid draw trays, and the like, associated with the mass transfer structures, which are not illustrated in FIG. 1 but would be included according to the knowledge of one skilled in the art.

The type and number of mass transfer structures included in mass transfer column 12 may be selected to achieve the desired separation within the mass transfer column 12. In some embodiments, the mass transfer structures of the mass transfer column 12 may comprise one or more mass transfer trays 34 (e.g., cross-flow trays) disposed in the internal region 18 and arranged in a vertically-spaced apart relationship with respect to one another as generally shown in FIG. 1. Each of the mass transfer trays 34 comprises a generally planar tray deck 36. Most of the surface area of the tray deck 36 includes apertures (not shown in FIG. 1) to permit an ascending vapor (or liquid) stream to pass through the tray deck 36 and interact with a liquid stream passing along an upper surface of the tray deck 36. The apertures can be in the form of simple sieve holes or directional louvers, or they may include structures such as fixed or movable valves. The portion of the tray deck 36 including the apertures is known as the active area of the tray 34. The trays 34 may be single-pass or multiple-pass trays.

Each of the mass transfer trays 34 includes one or more openings in the tray deck 36 to allow liquid that flows across the tray deck 36 to enter the openings and descend downwardly through the mass transfer column 12. At least a portion or all of the openings in the tray deck 36 may be associated with a downcomer 38 that extends downwardly from the tray deck 36 to deliver the liquid that enters the opening of the upper tray deck 36 onto the tray deck 36 of an underlying one of the mass transfer trays 34. Each downcomer 38 is defined by one or more walls 40 and, optionally, by one or more portions of the shell 16. Additionally, the mass transfer trays 34 may include at least one weir 42 for maintaining a liquid level on the upper surface of the tray deck 36.

In some embodiments, the mass transfer structures may comprise structured packing (not shown). The structured packing may be used in addition to, or in place of, the mass transfer trays 34. The structured packing may include a plurality of corrugated sheets or plates in contact with one another to improve the contact area between the fluids within the mass transfer column 12 (e.g., vapor-liquid contact or liquid-liquid contact). The structured packing may be formed from any rigid material inert to, or compatible with, the fluids and conditions present during the operation of mass transfer column 12. The structured packing may or may not include apertures for permitting vapor and/or liquid to pass therethrough. One example of the structure packing suitable for use in the mass transfer column 12 is described in U.S. Pat. No. 6,478,290, the entire disclosure of which is incorporated herein by reference to the extent not inconsistent with the present disclosure. The mass transfer column 12 may include multiple zones of structured packing, spaced apart from one another vertically along the height of the column (or horizontally along its length, depending on the orientation of the mass transfer column 12), or the mass transfer column 12 may include only a single packing zone.

In some embodiments, the mass transfer structures 34 in the mass transfer column 12 may comprise random packing. The random packing may be used in addition to, or in place of, the mass transfer trays 34 and/or the structured packing. The random packing may comprise any of various types of discreet, loose elements arranged in contact with one another and used to improve the contact between the fluid phases with the mass transfer column 12. The random packing may be formed from any suitable material, such as metal, plastic, ceramic, or combinations thereof, which is inert to, or compatible with, the operating conditions of the mass transfer column 12. The random packing may be in any of various forms, including rings, saddles, and cylinders, and can be of any suitable size. One example of the random packing suitable for use in column 12 is described in U.S. Pat. No. 7,722,945, the entire disclosure of which is incorporated herein by reference to the extent not inconsistent with the present disclosure.

In some embodiments, the mass transfer column 12 may be a reactive distillation column in which a chemical reaction takes place within or between the fluid phases being separated within the mass transfer column 12. Such reactions are often carried out in the presence of a catalyst. In some embodiments when the mass transfer column 12 is a reactive distillation column, the mass transfer column 12 may further include a bed of solid catalyst particles through which the fluid phases flow and are contacted to facilitate heat and mass transfer along with promoting the chemical reaction. In other embodiments, the catalyst can be a liquid catalyst and may be present in the feed or otherwise added to the mass transfer column 12 at one or more locations.

Turning again to FIG. 1, the automatic control system 14 is used to control the operation of the mass transfer column 12 and the process(es) occurring therein. The automatic control system 14 may include a combination of hardware, such as controllers, memory, and sensors, and software, such as computer readable instructions stored in memory that, when executed by at least one processor, implement the functionality of the automatic control system 14, embodiments of which are described herein. The automatic control system 14 may be or comprise any suitable type of process control system, including, for example, a distributed control system (DCS) or a supervisory control and data acquisition system (SCADA) system. It may provide feedback control, feed forward control, or both feedback and feed forward control.

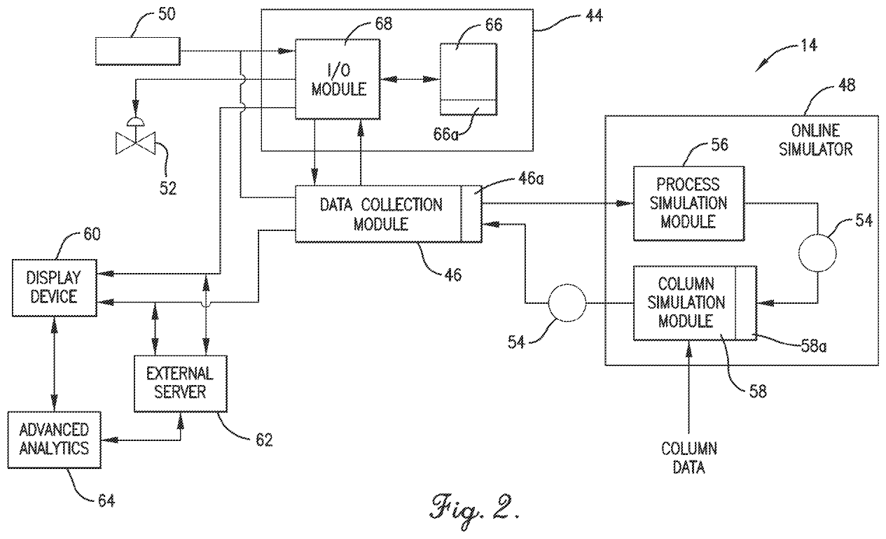

Turning now to FIG. 2, one embodiment of the automatic control system 14 for use in a variety of embodiments of the mass transfer system 10, including the mass transfer system 10 shown in FIG. 1, is schematically illustrated. As shown in FIG. 2, the automatic control system 14 includes at least one controller 44, a data collection module 46, an online simulator 48, a plurality of field data collection devices, represented in FIG. 2 as sensor/transmitter 50, and a plurality of field control devices, represented in FIG. 2 as a control valve 52. The automatic control system 14 optionally includes one or more data translation modules 54 located within or subsequent to the online simulator 48. As shown in FIG. 2, the online simulator 48 comprises a process simulation module 56 and a column simulation module 58. The automatic control system 14 may also include at least one display device 60, at least one external server 62, and an optional advanced analytics module 64. Each of these components, as well as the interaction therebetween, is discussed in further detail below.

The field data collection devices, represented in FIG. 2 by the sensor/transmitter 50, are configured to determine the value of at least one operating parameter and to transmit a signal corresponding to that value from the sensor/transmitter 50 to another element within the automatic control system 14. In some embodiments, the field data collection device 50 can include one or more temperature, pressure, flow, level, or composition sensors, transmitters, and/or transducers, which may be configured to transmit signals to one or more of the controllers 44 or directly to the data collection module 46 of the automatic control system 14. In some cases, the sensor/transmitter 50 may be hard wired to the automatic control system 14, while in other embodiments, all or a portion of the transmission may be done wirelessly.

Turning again to FIG. 1, the automatic control system 14 is shown as including several of the field data collection devices 50a-g Each of field data collection devices 50a-g may be a sensor configured to measure a physical quantity, such as temperature, pressure, flow rate, level, or composition, and/or a transmitter configured to transmit a signal corresponding to a measured value of one or more process parameters to another component within the automatic control system 14. In some embodiments, the field data collection devices 50a-g may be transducers configured to both measure and transmit data related to at least one physical property of the mass transfer system 10. Each of field data collection devices 50a-g may take measurements at a single point or may take measurements at a plurality of points.

Suitable embodiments of the temperature sensors can include, but are not limited to, thermocouples, resistance temperature detectors (RTDs), thermistors, and semiconductor-based temperature sensors. Suitable embodiments of the pressure sensors can include, but are not limited to, potentiometric pressure sensors, inductive pressure sensors, capacitive pressure sensors, piezoelectric pressure sensors, strain gauge pressure sensors, resonant wire pressure sensors, and variable reluctance pressure sensors. Examples of suitable embodiments of the flow sensors (also called flow meters) include, but are not limited to, rotameters, spring and piston flow meters, ultrasonic flow meters, turbine flow meters, paddlewheel sensors, vortex meters, differential pressure flow meters (pitot tubes), positive displacement flow meters, velocity flow meters, mass flow meters, and open channel flow meters. Suitable embodiments of the level sensors may include, but are not limited to, optical level switches, capacitance level sensors, ultrasonic level sensors, microwave/radar level sensors, vibrating level sensors, conductivity level sensors, and float switches. One or more of the sensors used may be optical fiber sensors such as, for example, a Brillouin distributed optical fiber sensor from Oz Optics in Ontario, Canada.

Additionally, the mass transfer system 10 may include at least one field data collection device 50f,g disposed within the open internal region 18 of the mass transfer column 12. When located within the mass transfer column 12, the field data collection devices 50f,g may be configured to measure process parameters at or near the active surface of at least one of the tray decks 36, in or near one of the downcomers 38, or in the space between overlying and underlying ones of the mass transfer trays 34. In some embodiments, the process parameters measured by the field data collection devices 50f,g include one or more of pressure, temperature, level, composition, and flow rate, while, in other embodiments, the process parameters measured by the column field data collection devices 50f,g include column process parameters such as downcomer liquid level, liquid level on draw trays located throughout the mass transfer column 12 for collecting liquid prior to its removal from the side of the mass transfer column 12, and depth of liquid in the sump or sump partitions at the bottom portion of the mass transfer column 12. In some embodiments, the automatic control system 14 may include a single field data collection device 50 within the mass transfer column 12, while in other embodiments, two or more field data collection devices 50 may be present. When multiple ones of the field data collection devices 50 are present, they may be spaced apart from one another vertically along the height of the mass transfer column 12. This permits the field data collection devices 50, in conjunction with the automatic control system 14, to monitor one or more parameters at multiple locations along the column. This may include monitoring the pressure, temperature, composition, or liquid level at every mass transfer structure, such as the mass transfer trays 34, in the mass transfer column 12.

When measuring values for fluid flow rate and level on or near the mass transfer structures within the mass transfer column 12, any suitable type of sensor can be used, including one or more of those listed previously. In some embodiments, a fiber optic sensor may be used for determining liquid level. One example of such a sensor is described in U.S. Pat. Nos. 9,645,002 and 9,651,415, the entireties of which are incorporated herein by reference to the extent not inconsistent with the present disclosure. These sensors utilize a fiber Bragg grating sensor in combination with a heating element to detect a liquid level by using the difference in heat dissipation between the liquid and vapor phases.

Referring again to FIG. 2, in some embodiments, the output from one or more field data collection devices 56 is transmitted to the controller 44 and/or the data collection module 46 of the automatic control system 14. Signals may be transmitted pneumatically and/or electronically and via an analog or digital signal. The signals may be transmitted from the field data collection device 50 via a hard wire connection and/or it may be done wirelessly.

The controller 44 may be any suitable type of process controller for adjusting the operation of at least a portion of mass transfer system 10. The controller 44 may be an automatic process controller including at least one processor 66, a memory 66a, and optionally at least one input-output module (I/O module) 68. In some embodiments, the controller 44 may further include software, such as computer readable instructions stored in the memory 66a, which, when executed by the processor 66, implement the functionality of the automatic control system 14, and components thereof, as discussed herein. The I/O module 68 receives a signal from one or more field data collection devices 50 and transmits the information in a readable form to the processor 66. The processor 66 analyzes the measured parameter value and generates one or more output controls, which pass through the I/O module 68 and to a field control device, shown in FIG. 2 as a control valve 52. Other types of field control devices 52 include, but are not limited to, control valves, pumps, and switches. These field control devices 52 may be configured to receive and execute output controls from the controller 44 in order to monitor and/or adjust the operation of the mass transfer system 10.

For example, the controller 44 may receive a signal corresponding to the measured value for temperature from a temperature sensor of the mass transfer column 12 (not shown in FIG. 2). The I/O module 68 of the controller 44 receives the signal and transmits it to the processor 66 of the controller 44. The processor 66 then analyzes the measured value and, based on that analysis, generates one or more output controls, which are passed through the I/O module 68 of the controller 44 and to the field control device 52. The output controls received from the controller 44 at the field control device 52 (e.g., a flow control valve) are used to adjust the flow rate of, for example, the reflux stream introduced into the mass transfer column 12, thereby achieving a desired value for the temperature of the overhead stream.

The field control devices 52 may be located at one or more locations within the mass transfer system 10. Some examples include flow control valves on the feed line 20 and the upper and lower takeoff lines 22 and 24, as shown in FIG. 1. Additionally, flow control valves may be present on the boil up line out of the reboiler 28, as well as on the reflux line back to the mass transfer column 12. One or more flow control valves may be located on the heat transfer media (e.g., steam or water) lines into the heat exchangers of the system 10. In other embodiments, the field control device 52 may be a level control switch or a switch to start or stop a pump.

In some embodiments, the controller 44 may be a programmable logic controller (PLC). When controller 44 is a PLC, it may be configured to compare the measured parameter value with a predetermined set point for that parameter to determine a difference, or an “off set,” between the target set point value and the actual measured value. In other embodiments, the measured parameter value may be transmitted to an external server 62 via a network connection, wherein the comparison of the measured parameter value and the set point value may be carried out.

Based on the off set, one or more output controls may be generated by the controller 44. Examples of possible output controls may include (1) refine the set point; (2) compare with other off sets taken from similar or related ones of the mass transfer column 10 or from redundant field data collection devices to determine if there is a malfunction with one of the field data collection devices; (3) alert the operations personnel of the mass transfer column 12 of a potentially problematic deviation from the target set point or from design conditions (e.g., vessel maximum pressure or temperature); (4) anticipate upcoming performance fluctuations or undesired operating events (as in feed forward control); (5) change a process control parameter of the mass transfer system 10; and (6) any combination thereof. Additionally, the raw and/or semi-processed data from the field data collection device 50, the controller 44, and/or the field control device 52 may be sent, via the process data collection module 46, to the display device 60 for monitoring the performance of the mass transfer column 12. Further, some portions or all of the raw and/or semi-processed data from the field data collection device 50, the controller 44, and/or the field control device 52 may be transmitted to the external server 62 (e.g., a server within the facility, a server owned by the operations personnel of the mass transfer column 12, or a cloud server) for further processing and/or analysis.

The controller 44 is configured by firmware (which may also be known as software) incorporating machine-readable instructions and stored in the memory 66a of the controller 44 to compare the measured parameter value of mass transfer column 12 with the predetermined set point for that parameter, thereby determining the off set. Based on that off set, the controller 44 may be configured to adjust the operation of the mass transfer system 10 to maintain the target set point for that parameter. In some embodiments, the controller 44 may execute further machine readable instructions of software or firmware in the processor 66 to determine if the measured parameter value represents a dangerous situation, such as excessive temperature or pressure, and activate an alarm or safety interlock in order to restore safe operation.

As shown in FIG. 2, the automatic control system 14 may further comprise the data collection module 46 for receiving and storing process data collected from the field data collection devices 56 and/or the controllers 50. The data collection module 46 may also include a memory 46a for storing the collected data and may also be configured to transmit data from its memory 46a to at least one of the controllers 44. The data transmitted from the data collection module 46 to the controllers 50 may be used in the analysis performed by the controller 44 and used to control the operation of the mass transfer system 10. Additionally, the data collection module 46 may be configured to transmit data to the display device 60 and/or to the external server 62, which can be used to provide information to the operations personnel of the system 10 in close to real-time and/or for analysis of system performance in optimization and/or troubleshooting. The data collection module 46 stores data in its memory 46a and/or on the external server 62. The data collection module 46 may also be configured to perform some basic calculations (e.g., pressure drop or temperature drop) and store and/or display the results of these calculations in its memory 46a, the display device 60, and/or the external server 62.

As shown in FIG. 2, the automatic control system 14 may also include the online simulator 48 for performing online simulations to provide output controls used to control the operation of the mass transfer system 10. Although shown as “online” (e.g., implemented on the cloud, or in connection with the cloud computer system), the online simulator 48 may be an entirely internal component of the automatic control system 14, such that all functionality of the online simulator 48 is described on premises at the location of the automatic control system 14 without requiring data transfer to the cloud. In contrast to controller 44, the online simulator 48 uses process data to perform detailed process simulations and create multiple column profiles, which are then used to provide close to real-time values for key column performance parameters not usually available in real-time. These key column performance parameters include, but are not limited to, tray entrainment, tray froth height, tray jet flood, tray weeping, tray downcomer backup, tray downcomer choke flooding, maldistribution in trays or packing, packing percentage of flood, and packing liquid hold-up.

The online simulator 48 shown in FIG. 2 includes a process simulation module 56 and a column simulation module 58. The process simulation module 56 and the column simulation module 58 may include computer readable instructions that, when executed by a processor, implement the functionality described herein of the process simulation module 56 and the column simulation module 58, respectively. The process simulation module 56 is configured to receive process data from the data collection module 46 and calculate a process profile of the mass transfer column 12. The process simulation module 56, in embodiments, utilizes (but is not limited to) first principle calculations based on thermodynamics, mass, and energy balances to determine the liquid and vapor volumetric flow profiles in the column. The process simulation module 56 may also determine temperature, pressure, and composition profiles in the mass transfer column. Examples of types of profiles provided by the process simulation module 56 include a hydraulic profile, a temperature profile, a pressure profile, and a composition profile. The profile includes values for at least one operating parameter, such as temperature, pressure, flow, level, and composition, measured over time and/or at various spaced apart locations within the system 10. In some embodiments, the process simulation module 56 calculates all of the above profiles and provides a complete process profile of column 12. In some embodiments, at least a portion of the process data may be manually input off-line from one or more users.

The output profile from the process simulation module 56 may pass through at least one data translation module 54, wherein the data can be converted from one syntax to another in order to provide to the data in a form more readable by column simulation module 58, if needed. The data translation module 54 can include any suitable type of hardware and/or software needed to translate the output of the process simulation module 56 to a syntax readable by the column simulation module 58. In some cases, the data translation module 54 may be integrated with the process simulation module 56 and/or the column simulation module 58 and may not be a separate component. In other embodiments, no data translation module 54 is used in automatic control system 14.

As shown in FIG. 2, the column simulation module 58 receives the process profile output from the process simulation module 56. Additionally, the column simulation module 58 receives specific data regarding the specific geometry and dimensions of the column being simulated. Examples of this data include the number of trays, type of trays, tray spacing, tray active area, size and lay out of tray apertures, downcomer dimensions, weir height, location of draw trays, location of vapor return relative to trays, column diameter, design values for column parameters (temperature, pressure, composition, flow rate), maximum values for column parameters (temperature, pressure, composition, flow rate), packing type, packing size, packing pressure drop, packing specific surface area, packing spacing, liquid distributor size, spacing, and layout, packing height per section and overall, and combinations thereof. Such information may be input into the system by a user, such as an operator, an engineer, or a vendor, and it may be stored in a memory 58a of the column simulation module 58 for future simulations.

Based on the column profile provided by the process simulation module 56 and the user-input data regarding the mass transfer column 12 internals, the column simulation module 58 performs a detailed simulation of the mass transfer column 12, including calculating the temperature, pressure, flow rate, and composition at each mass transfer tray 34 or section of packing within the mass transfer column 12. Based on these calculations, the column simulation module 58 provides an output signal corresponding to values for one or more of the following column performance parameters: tray entrainment, tray froth height, tray jet flooding, tray weeping, tray downcomer backup, tray downcomer choke flooding, fluid maldistribution on trays, packing percentage of flood, packing liquid hold-up, and fluid maldistribution in packing.

Since values for these column performance parameters are calculated while the process is operating and are based on real-time process parameter values (and real-time process profiles from the process simulation module 56), the values provided by the column simulation module 58 for the column performance parameters are in or near real-time. This contrasts with conventional calculations for determining these parameters, which are usually conducted off-line and include a significant time lag between acquisition of the process data and the final calculated results. As a result, the values for these key column performance parameters may be used in day-to-day operations of the mass transfer column 12, as well as for more efficient troubleshooting, debottlenecking, and optimization of the performance of the mass transfer column 12.

As shown in FIG. 2, the output from the column simulation module 58 can optionally be sent through another data translation module 54, to convert the output signal from the column simulation module to a signal readable by the process data collection module 46. The processed or unprocessed output data from the column simulation module 58 is then transmitted to the data collection module 46, wherein it may be stored and/or further transmitted to other components of the automatic control system 14. The processed or unprocessed output data from the column simulation module 58 may additionally be used in the control loop of the controller 44 to implement automatic control of the mass transfer column 12. For example, when the processed or unprocessed output data from the column simulation module 58 indicates a safety or efficiency threshold is breached, the control system 14 may implement shutdown or decreased throughput via control of the input feed line 20.

For example, in some embodiments, the values for the column performance parameters calculated by the column simulation module 58 may be sent to the display device 60, wherein the value may be displayed, in real-time, for at least one end user. Examples of suitable display devices 60 include external computers, hand-held or wall-mounted human-machine interfaces (HMIs), main graphic display unit, or other local or remote screens. The measured column parameter values from column simulation module 58 may be displayed along with other process parameter data (e.g., temperature, flow, pressure, etc.) from the data collection module 46.

Display of these calculated column performance parameters assists operations personnel with identifying and addressing non-optimal operating conditions early, thereby minimizing negative impact on performance of the mass transfer column 12. For example, the automatic control system 14 may display real-time values for tray froth height and downcomer liquid level calculated by the column simulation module 58, along with the pressure drop across the set of trays and bottom liquid flow rate from one or more of the controllers 44 in the automatic control system 14. If the monitored mass transfer trays 34 were to beginning to flood, the operations personnel would likely first be notified of the abnormal liquid levels on the mass transfer trays 34 and/or in the downcomers 38 by the values of the tray froth height and/or downcomer liquid level provided by the column simulation module 58. This would likely occur before the actual flooding of the mass transfer column 12 caused an increased pressure drop and/or reduced bottom liquid flow rate. Thus, rather than wait for the tray flooding to become severe enough to impact the pressure drop and bottom liquid flow, the operations personnel could see the warning signs of flooding sooner and on a tray-by-tray basis, thereby permitting more rapid (and likely less severe) corrective action.

The calculations of these mass transfer column 12 performance parameters are carried out in the column simulation module 58 on the basis that the mass transfer column 12 and its ancillary equipment (such as piping, valves, etc.) have been installed and are operating in a correct and like-new manner. Deviations from this idealized assumption in the actual mass transfer column 12 may impact the calculated values of the column performance parameters. Thus, any differences between the measured values provided by the column simulation module 58 and other values calculated from the design of the system, for example, can be used to identify and address structural, operational, and mechanical deficiencies of the mass transfer column 12. Previously, many of these issues have been difficult to detect and often required shutdown of the mass transfer column 12 and offline inspection to accurately identify the source of the problem.

Optionally, the data from the column simulation module 58 may pass through the external server 62, where it may be stored and/or accessed by one or more end users as real-time or historical data. The display device 60 and the external server 62 may be electronically connected to the data collection module 46 by hardwire network connections and/or wirelessly. Data from the column simulation module 58 stored in the server 62 may then be used for column optimization, as well as for debottlenecking or off-line troubleshooting. For example, a measured value (or trend of measured values over time) for one of the mass transfer column 12 performance parameters (e.g., froth height) may be compared with a target value for that parameter calculated at the same conditions to determine an off set. The offset, if any, can then be used to locate additional problems within the column such as, for example, fouling, coking, tray damage, distributor damage, or other sources of vapor and/or liquid maldistribution. In other embodiments, an analysis may be performed to determine how close the mass transfer column 12 is to its design operating limits and, based on this, make changes in the operation of the mass transfer column 12 to bring the mass transfer column 12 closer to these limits without adversely impacting the performance of the mass transfer column 12.

Such analyses can be done offline by an end user or can be done as part of the advanced analytics module 64 of the automatic control system 14. When performed by the advanced analytics module 64, the output from the advanced analytics module 64 may be transmitted to at least one of the display devices 60, the external server 62, and/or the data collection module 46, wherein at least a portion of the output control can be used to control operation of various aspects of the mass transfer column 12. The output of the advanced analytics module 64 can be used to make predictions of future behavior of the unit, which may be used to optimize system performance and/or to expand the existing system or design a new similar system.

The following Examples illustrate the use of the mass transfer system 10 to control the performance of embodiments of the mass transfer column 12 and are not intended to limit the scope of the present invention in any way.

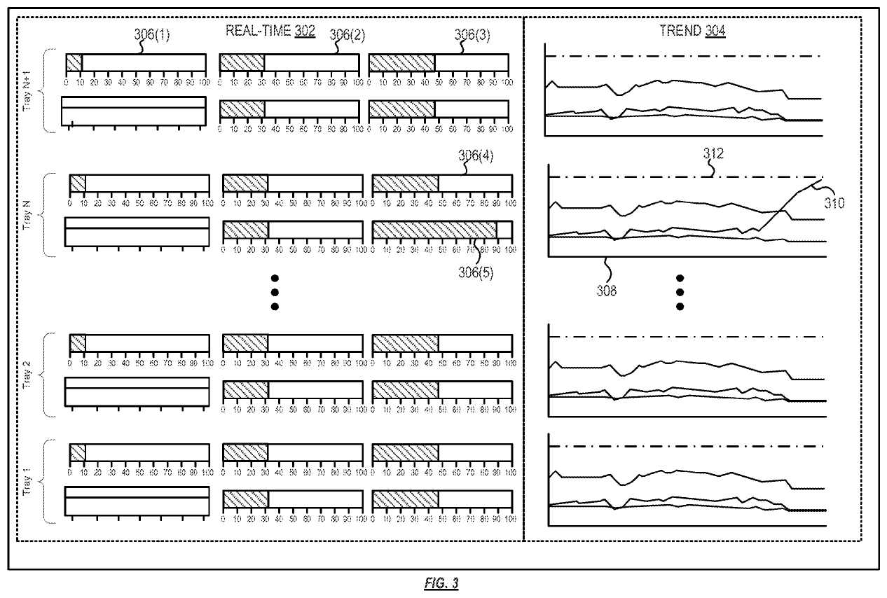

FIG. 3 depicts an example screen for displaying on the display 60 including the data from the column simulation module 58. As shown, the display is particularly user-friendly in its setup, which allows operators to quickly analyze and locate potential problems in the mass transfer column 12. The displayed data includes a real-time (or near real-time) section 302, and a trend section 304. Each tray (or other hardware device in the mass transfer column 12) of the real-time section 302 and the trend section 304 are represented horizontally on the display screen. This allows the operator to pinpoint the location of a potential error in the system.

As shown, there are a plurality of variables 306, 308, 310, 312, 314 shown for each tray. FIG. 3 is shown illustratively, show the variables are not labeled, but it should be appreciated that any calculatable variable may be shown including, but not limited to, tray entrainment, tray froth height, tray jet flood, tray weeping, tray downcomer backup, tray downcomer choke flooding maldistribution in trays, packing percentage of flood, packing liquid hold-up and maldistribution in packed beds, the depth of the froth on the tray deck (indication of percentage of flood and possible entrainment), depth of fluid in the downcomer of the tray (% back-up flood), depth of liquid on draw trays in packed or trayed towers, depth of liquid in the sump or partitions in the sump, other desired variables, and any combination thereof. Moreover, although six variables 306 are shown per tray, any number of variables may be shown (so long as there is enough screen space on display 60) without departing from the scope hereof. Furthermore, the variables may not be the same for each tray. The operator may select one set of variables for one (or more) trays, and another set of variables for another (or more) trays.

The trend section 304 shows a time-series history graph of one or more of the variables 306. The trend section 304 may show trends for the same variables shown in the real-time section 302, or other variables that are not selected for the real-time section 302. Moreover, the same, fewer, or more variables may be shown for each time-series history graph.

As discussed above, the ability to display variables 306 in both real-time section 302 and trend history section 304 allows the operator to pinpoint the location of a potential error in the system and gain on-the-fly insight into the operation of the mass transfer system 12 without shutdown. As shown in the real-time variable value 306(5), that value is nearing a 90% threshold. The corresponding history trend in graph 308 shows that the trend line 310 corresponding to variable 306(5) is nearing a safety/efficiency threshold 312. The majority of the other variables 306 in that tray are not showing potential error in the system. By viewing the trend line 310, the operator could adequately note that the variable 306(5) is approaching the safety/efficiency threshold 312 well before actually reaching the threshold 312. Furthermore, the automatic control system 14 may also analyze the trend line 310 (e.g., monitor slope thereof) and automatically shut down, or control an associated hardware device with that tray to prevent the variable from ever reaching the safety/efficiency threshold 312.

The inventors have implemented the systems and methods described herein to evidence significant advantages in the field. The systems and methods herein were implemented at an internal testing facility to troubleshoot two identically-designed mass transfer systems that were operating according to typical control schemes (monitoring sensed variables and managing the control of the system based on operator expertise and/or scheduled control). These two identically-designed mass transfer systems would flood at seemingly random times when the operators believed the mass transfer systems were running below the designed maximum capacity. The operators could not identify why the systems were flooding because different sets of operating characteristics would trigger the flood. With the addition of the process simulation module 56 and a column simulation module 58 discussed above, the operators were able to achieve visualization of the interior operation of the mass transfer system that they had never had before. Accordingly, the operator was able to realize the flooding occurred at the precise calculated conditions because the designed characteristics were not equivalent to the in-operation characteristics. This evidences the advantage that the systems and methods described herein provide insight into the mass transfer system as installed versus as designed, thereby accounting for potential installation discrepancies in comparison to the system as designed. One such discrepancy that was identified involved a feed system. The measured data was continuously offset from the calculated data output by the process simulation module 56 and the column simulation module 58 near a designed feed point. Upon further review, the operators were able to identify that a feed line had been installed at an incorrect location, thereby causing a flooding condition in the mass transfer system that would not have occurred if the feed line had been installed at the designed location.

From the foregoing, it will be seen that this invention is one well adapted to attain all the ends and objectives hereinabove set forth, together with other advantages that are inherent to the invention.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

1-4. (canceled)

5. A mass transfer system comprising:
a mass transfer column for processing fluid streams to cause mass transfer and/or heat exchange between the fluid streams, said mass transfer column comprising:
an external shell;
an open internal region defined by the external shell; and
a plurality of mass transfer structures disposed within the external shell for facilitating contact between two fluid streams within the external shell; and
an automatic control system for calculating at least one column performance parameter related to said mass transfer column in real-time, said automatic control system comprising:
at least one controller configured for adjusting operation of the mass transfer system;
a plurality of field data collection devices configured for collecting process data from said mass transfer system;
at least one data collection module configured for receiving and storing process data received from said field data collection device;
a plurality of field control devices configured to receive and execute output controls from the controller to adjust operation of the mass transfer system; and
an online simulator configured to use the process data to perform process simulations and create process profiles for operating parameters measured over time and/or at spaced apart locations within the automatic control system and for calculating column performance parameters from said process data.

6. The mass transfer system of claim 5, wherein the process profiles comprise one or more of a liquid volumetric flow profile, a vapor volumetric flow profile, a temperature profile, a pressure profile, a composition profile, and a hydraulic profile.

7. The mass transfer system of claim 6, wherein the column performance parameters comprise one or more of tray entrainment, tray froth height, tray jet flood, tray weeping, tray downcomer backup, tray downcomer choke flooding, tray maldistribution, packing percentage of flood, packing liquid hold-up, and packing maldistribution.

8. The mass transfer system of claim 7, including a process simulation module configured to perform the process simulations and create the process profiles and a column simulation module configured for receiving the process column profiles from the process simulation module and performing an operational simulation of the mass transfer column and calculating the column performance parameters.

9. The mass transfer system of claim 8, including a display device configured for receiving and displaying the column performance parameters calculated by the column simulation module.

10. The mass transfer system of claim 9, wherein said display device is configured for displaying the column performance parameters in real time and as a history trend.

11. The mass transfer system of claim 5, wherein said controller is configured to receive signals from the field data collection devices, perform an analysis of the signals, and then generate the output controls from the analysis.

12. The mass transfer system of claim 11, wherein said controller comprises at least one processor, a memory, and at least one input-output module.

13. The mass transfer system of claim 5, wherein the field data collection devices are one or more of a temperature sensor, a pressure sensor, a flow sensor, a level sensor, and a composition sensor.

14. The mass transfer system of claim 13, wherein the field data collection devices include transmitters configured to transmit a signal corresponding to a measured value from the temperature sensor, the pressure sensor, the flow sensor, the level sensor, and/or the composition sensor.

15. The mass transfer system of claim 13, wherein the field control devices include one or more of a control valve, a pump, and a switch.

16. The mass transfer system of claim 15, wherein the process profiles comprise one or more of a liquid volumetric flow profile, a vapor volumetric flow profile, a temperature profile, a pressure profile, a composition profile, and a hydraulic profile.

17. The mass transfer system of claim 16, wherein the column performance parameters comprise one or more of tray entrainment, tray froth height, tray jet flood, tray weeping, tray downcomer backup, tray downcomer choke flooding, tray maldistribution, packing percentage of flood, packing liquid hold-up, and packing maldistribution.

18. The mass transfer system of claim 17, including a process simulation module configured to perform the process simulations and create the process profiles and a column simulation module configured for receiving the process profiles from the process simulation module and performing an operational simulation of the mass transfer column and calculating the column performance parameters.

19. The mass transfer system of claim 18, including a display device configured for receiving and displaying the column performance parameters calculated by the column simulation module.

20. The mass transfer system of claim 19, wherein said display device is configured for displaying the column performance parameters in real time and as a history trend.

21. A method for controlling a mass transfer system, said method comprising:
introducing a feed stream into a mass transfer column of said mass transfer system;
contacting at least a portion of said feed stream with at least one mass transfer element in said column to facilitate interaction between two or more fluid phases therein; and
during at least a portion of said contacting, calculating and displaying a real-time value for at least one column performance parameter with an automatic control system by:
measuring process data of said mass transfer system with a plurality of field data collection devices;
simulating the operation of said mass transfer system with the measured process data to provide process profiles, wherein said operation simulating is carried out with a process simulator module of an automatic control system;
simulating the performance of a mass transfer column of said mass transfer system with said simulated process profiles to provide column performance parameter values, wherein said performance simulating is carried out with a column simulator module of said automatic control system; and
displaying said column performance parameter values to at least one user via a display module.

22. The method of claim 21, including displaying the column performance parameter values in real time and as a history trend.

23. The method of claim 21, wherein the mass transfer column profiles comprise one or more of a liquid volumetric flow profile, a vapor volumetric flow profile, a temperature profile, a pressure profile, a composition profile, and a hydraulic profile.

24. The method of claim 23, wherein the column performance parameter values comprise one or more of tray entrainment, tray froth height, tray jet flood, tray weeping, tray downcomer backup, tray downcomer choke flooding, tray maldistribution, packing percentage of flood, packing liquid hold-up, and packing maldistribution.
